(19) United States
(12) Patent Application Publication
(10) Pub. No.: US 2005/0236872 A1
(43) Pub. Date: Oct. 27, 2005

(54) Roof liner of a vehicle comprising a light source mounted on a sliding roof

(75) Inventor: Thomas Raaf, Talheim (DE)

Correspondence Address: FITCH, EVEN, TABIN & FLANNERY, P. O. BOX 65973, WASHINGTON, DC, 20035, US

(73) Assignee: DaimlerChrysler AG, 70567 Stuttgart (DE)

(21) Appl. No.: 10/506,188

(22) PCT Filed: Feb. 7, 2003
(86) PCT No.: PCT/EP03/01201

§ 371 Date: Jun. 24, 2005

(30) Foreign Application Priority Data
Mar. 1, 2002 (DE) 102 08 805.5

(51) Int. Cl. B60J 7/00

(52) U.S. Cl. 296/214

(57) ABSTRACT

In a roof liner of a vehicle having a light source which is arranged on a movable sliding liner, the roof liner having a transparent roof liner segment and it being possible to close the area underneath the transparent roof liner segment by means of the sliding liner, the sliding liner has first contact means which are electrically connected to the light source, and the roof liner is fitted with second contact means which are electrically connected to the on-board power system, the contact means being electrically conductively connected to one another when the sliding liner is closed, in order to supply energy to the light source. These measures avoid complex routing of electrical lines to supply energy to the light source.

The invention relates to a roof liner of a vehicle having a light source which is arranged on a movable sliding liner, the roof liner having a transparent roof liner segment, and it being possible to close the area underneath the transparent roof liner segment by means of the sliding liner.

Integrating technical light systems for optimizing the light conditions in the interior of a vehicle on the basis of the requirements of the vehicle occupants is the subject of current developments.

In order to illuminate the passenger compartment of a vehicle in the dark, for example a surface-lighting unit is additionally arranged in the vehicle. Surface-lighting units have a smaller tendency to throw shadows than spot-shaped light sources as a result of the illumination of a large surface. A specific embodiment of a surface-lighting unit is known from U.S. Pat. No. 5,079,675. The surface-lighting unit has a uniform distribution of light over a surface and is used to illuminate an object or a space. The surface-lighting unit has at least one panel, a light source being arranged on at least one side of the panel and a reflective body, which reflects the light into the panel, is arranged around said light source. Inclined reflective faces by which light which is incident in parallel is reflected by a predefined angle so that the light is emitted directed in a preferred direction, are provided in the panel on the opposite side of the preferred direction of the transparent panel, a reflective panel is arranged which reflects the light which is incident on it into the desired direction which is to be illuminated so that a uniform and intensive illumination is reached in a preferred direction.

In addition, DE 199 02 244 A1 describes a roof liner of a vehicle having a surface-lighting unit. The roof liner comprises a transparent roof element, it being possible to close the area underneath the transparent roof element by means of a sliding liner. The surface-lighting unit is mounted on the sliding liner on the inside of the vehicle and is moved along when the sliding liner is moved.

Energy is generally supplied to the surface-lighting unit here from the electrical on-board power system by means of electrical lines which are moved along with the movable sliding liner. The line length must be adequate here to prevent the connection being torn off during an opening or closing process of the sliding liner. In addition, sufficient storage room for the electrical lines and line ducts is required to guide the latter suitably.

The invention is then based on the object of specifying a roof liner of a vehicle having a light source which is arranged on a movable sliding liner and which ensures a simple, space-saving and reliable means of supplying power to the surface-lighting unit.

The object is achieved by means of the combination of features of patent claim 1.

In the case of the roof liner of a vehicle having a light source which is arranged on a movable sliding liner, the roof liner having a transparent roof liner segment and it being possible to cover or close the area underneath the transparent roof liner segment by means of the sliding liner, the sliding liner has first contact means which are electrically connected to the light source, and the roof liner is fitted with second electrical contact means which are electrically connected externally to an energy source (for example to a motor vehicle on-board power system), the first and second contact means being electrically conductively connected to one another when the sliding liner is closed, in order to supply energy to the light source.

The first electrical contact means which are preferably rigidly connected to the sliding liner are moved during a closing process in such a way that when the end position of the sliding liner is reached there is an electrically conductive connection to the second electrical contact means which are secured to the roof liner. Both components are preferably of metallic design and are thus electrically conductive. This method of forming contacts makes it possible to dispense with routing electrical lines while the sliding roof is moving, or with sliding contacts. A simple and reliable way of supplying power to the light source is thus ensured.

The second electrical contact means are preferably embodied as at least one pin contact. In this embodiment, the sliding liner moves, in its end position, against the pin contact. A particularly stable contact is formed as a result of the electrical contact means engaging one in the other, which contact is not destabilized even by severe vibration of the vehicle.

In particular, in the closing direction, the first electrical contact means can be arranged in the front lateral end area of the sliding liner. This embodiment avoids arranging the second electrical contact means in the area of the guide rails of the vehicle roof liner. The second electrical contact means are therefore not located in the area of the movement mechanism of the sliding liner, as a result of which the electrical contact means are attached in a stable fashion.

In a further embodiment of the invention, the light source is embodied as a surface-lighting unit, as a result of which particularly favorable illumination of the passenger compartment of the vehicle is brought about.

In particular, a voltage transformer for transforming the on-board power system voltage (for example 14 V or 42 V) is connected upstream of the second electrical contact means. In the case of a surface-lighting unit embodied as an electroluminescent film, the voltage is transformed up to, for example, 110 V. This permits high electrical voltages to be transmitted in the roof area.

Further advantageous embodiments of the invention are given in the subclaims.

The invention will be explained in more detail with reference to a plurality of exemplary embodiments in the figures, in which:

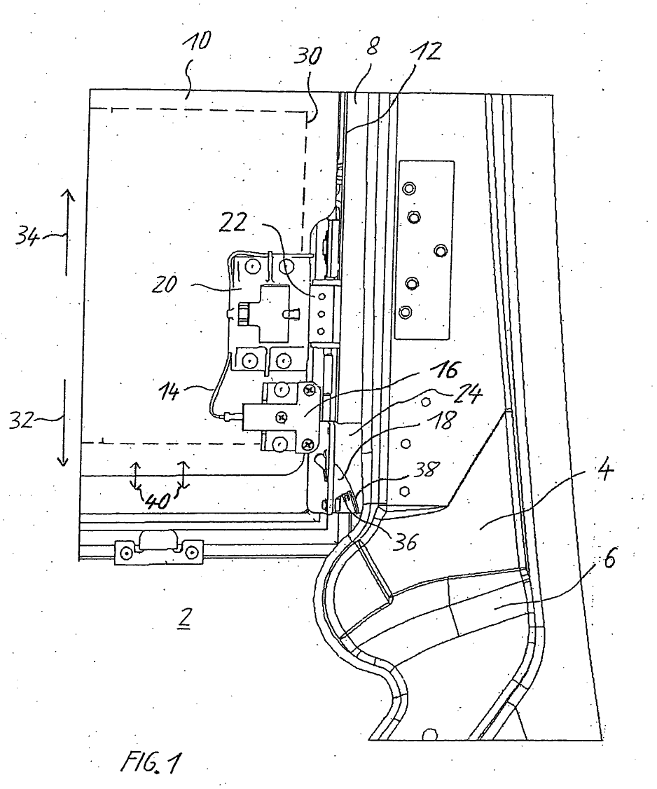

FIG. 1 shows a detail from a roof structure of a vehicle having a sliding liner in a schematic, plan view; and

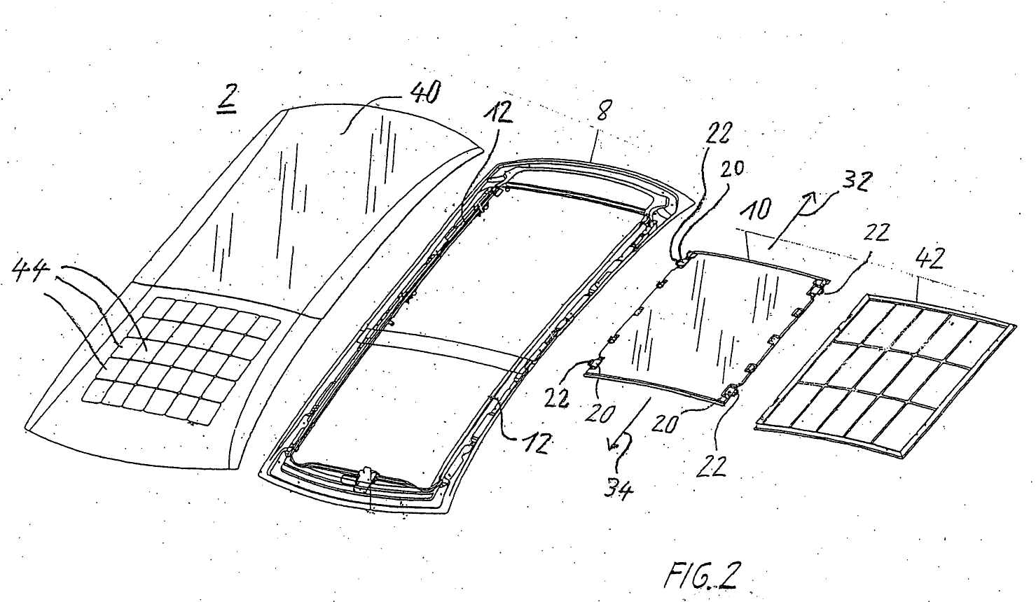

FIG. 2 shows a roof liner in a schematic exploded view.

The detail of a roof structure of a vehicle which is illustrated in FIG. 1 comprises a roof liner 2 with window elements 4 and carrier elements 6. In the central area of the roof liner 2, a guide frame 8 for a sliding liner 10 is arranged. A transparent roof liner segment 40 closes off the roof liner 2 at the liner side. The transparent roof liner segment 40 may be, for example, a glass roof or a transparent sliding roof.

The guide frame 8 has lateral guide rails 12 which extend essentially in parallel with the longitudinal axis of the vehicle and in which the sliding liner 10 is movably mounted. In the closed state, the sliding liner 10 covers the transparent roof liner segment 40 completely so that no natural light can pass from the outside into the passenger compartment of the vehicle through the transparent roof liner segment 40.

A light source 30, which is embodied in this exemplary embodiment as a surface-lighting unit embodied as an electroluminescent film, is arranged on the sliding liner 10, on the passenger compartment side. In this exemplary embodiment, the surface-lighting unit covers virtually the entire area of the transparent roof liner segment 40 when the sliding liner 10 is closed. However, surface-lighting units with a relatively small area coverage are also conceivable. The surface-lighting unit can also be embodied as described in U.S. Pat. No. 5,079,675.

The sliding liner 10 has first contact means 16 which are connected to the surface-lighting unit via an electrical line 14 and which are arranged, in the closing direction 32 of the sliding liner 10, in the front lateral end area on the upper side of the sliding liner 10. The opening direction 34 of the sliding liner 10 is opposed to the closing direction 32.

Second contact means 18 which are electrically conductively connected to the electrical on-board power system via the two connections 36, 38 are arranged on the guide frame 8 of the sliding liner 10 in such a way that the contact means 16, 18 are electrically conductively connected to one another when the sliding liner 10 is closed, in order to supply energy to the surface-lighting unit. This arrangement of the contact means 16, 18 in the front area permits simple mounting of the second electrical contact means 16 next to the guide rail 12.

The second electrical contact means 18 are arranged on a panel element 24 which is secured to the guide frame 8. The guide element 22 of the mounting element 20 of the sliding liner 10 is located in its end position in the end area of the guide rail 12. The contact means 18 are thus arranged adjacent to the end area of the guide rail 12.

The second electrical contact means 18 are embodied in this exemplary embodiment as two pin contacts which have a positive assignment or a negative assignment. An embodiment with only one pin contact which combines the positive assignment and negative assignment is also possible. In its end position, the sliding liner 10 moves onto the electrical contact means 18 and surrounds them in a latching position, as a result of which a stable electrical connection with a low space requirement is ensured when the sliding liner 10 is closed. It is possible to dispense with electrical lines which have to be additionally routed in order to supply power to the sliding liner 10. For the sake of better illustration, the sliding liner 10 in FIG. 1 is illustrated in a slightly opened state, indicated by the two double arrows 40. In exemplary embodiments which are not presented in any more detail, the two electrical contact means can also be attached to the sliding liner or to the guide frame at some other point. All that is necessary is to secure the electrical contact between the two contact means in the closed state of the sliding liner.

A voltage transformer (not illustrated in more detail) for transforming the on-board power system voltage is connected upstream of the second contact means 18. When an electroluminescent film is used as a surface-lighting unit, the on-board power system voltage is transformed up to 110 V. With the present arrangement for supplying energy to the surface-lighting unit which is arranged on the sliding liner 10 of the vehicle, a high electrical voltage which is necessary for the surface-lighting unit is thus transformed.

When the sliding liner 10 is closed, the electrical wiring can be configured in such a way that the surface-lighting unit is switched on automatically or is switched on by means of an operator controlled element in the passenger compartment of the vehicle. Such an operator control element may, for example, also be arranged in the roof liner 2 of the driver's area or in the accessible seat area of the other passengers either in the front or in the rear area of the vehicle.

Mounting elements 20, which engage with guide elements 22 in the guide rails 12, are arranged on the sliding liner 10, in the edge area, which permits the sliding liner 10 to be moved.

A panel 42 which can be switched between various translucent states is arranged on the side of the sliding liner 10 facing away from the transparent roof liner segment 40. The sliding liner 10 is thus arranged between the transparent roof liner segment 40 and the switchable panel 42. The switchable panel 42 is arranged mechanically independently of the sliding liner 10 in such a way that the sliding liner 10 can be moved with the surface-lighting unit independently of the switchable panel 42. The panel 42 is preferably switchable between a translucent and a partially translucent setting. The switching over is actuated, for example, by means of an operator control element in the passenger compartment of the vehicle. When the sliding liner 10 is opened and the panel 42 is switched to translucency, it is, of course, possible for light to enter the passenger compartment of the vehicle through the transparent roof liner segment 40, as if only the transparent roof liner segment 40 were present.

When the sliding liner 10 is opened and the panel 42 is switched to partial translucency, the light which enters through the transparent roof liner segment 40 is partially reflected back by the panel 42. The light then enters the passenger compartment of the vehicle in a highly diffuse fashion.

When the sliding liner 10 is closed, the surface-lighting unit is connected and the panel 42 is switched to translucency, the light from the surface-lighting unit is not altered by the panel. When the sliding liner 10 is closed, the surface-lighting unit is switched on and a panel 42 is switched to partial translucency, the light from the surface-lighting unit then enters the passenger compartment of the vehicle in a highly diffuse fashion.

FIG. 2 shows a detail of the roof liner 2 in a schematic exploded view. The roof liner 2 is partially covered with solar cells or with photovoltaic cells 44 which supply electrical loads or the like (for example on-board power system battery) with energy. The guide frame 8 of the sliding liner 10 is arranged on the side of the transparent roof liner segment 40 facing the passenger compartment of the vehicle. In the assembled state of the roof liner 2, the guide elements 22 of the mounting elements 20 of the sliding liner 10 engage in the guide rails 12 of the guide frame 8.

The panel 42 which can be switched between various translucent states is arranged on the side of the sliding liner 10 facing away from the transparent roof liner segment 40. The surface of the panel 42 covers the sliding liner 10 completely in the closed state of said sliding liner 10.

1. A roof liner (2) of a vehicle having a light source which is arranged on a movable sliding liner (10), the roof liner (2) having a transparent roof liner segment (40), and it being possible to cover the transparent roof liner segment (40) by means of the sliding liner (10), characterized in that
the sliding liner (10) is fitted with first contact means (16) which are electrically connected to the light source (30),
the roof liner (2) is fitted with a second contact means (18), and
when the sliding liner (10) is closed, the first and second contact means (16, 18) are electrically conductively connected to one another in order to supply energy to the light source (30).

2. The roof liner (2) as claimed in claim 1, characterized in that the second contact means (18) is embodied as at least one pin contact.

3. The roof liner (2) as claimed in claim 1 or 2, characterized in that the first contact means (16) are arranged in the closing direction (32) in the front lateral end area of the sliding liner (10).

4. The roof liner (2) as claimed in one of claims 1 to 3, characterized in that the light source (30) is automatically switched on when the sliding liner (10) is closed.

5. The roof liner (2) as claimed in one of claims 1 to 3, characterized in that the light source (30) can be switched on by means of an operator control element when the sliding liner (10) is closed.

6. The roof liner (2) as claimed in one of claims 1 to 5, characterized in that the light source (30) is embodied as a surface-lighting unit.

7. The roof liner (2) as claimed in claim 6, characterized in that the surface-lighting unit is embodied as an electroluminescent film.

8. The roof liner (2) as claimed in one of claims 1 to 7, characterized in that a voltage transformer is connected upstream of the second contact means (18).

9. The roof liner (2) as claimed in one of claims 1 to 8, characterized in that a panel (42) which can be switched between various translucent states is arranged on the side of the sliding liner (10) facing away from the roof liner segment (40).

10. The roof liner (2) as claimed in one of claims 1 to 9, characterized in that the sliding liner (10) is arranged in guide rails (12) in a movably guided fashion.

11. The roof liner (2) as claimed in claim 10, characterized in that the guide rails (12) are a component of a guide frame (8) which is attached to the roof liner (2).

12. The roof liner (2) as claimed in claim 11, characterized in that the second contact means (18) are attached to the guide frame (8).
